(19) United States
(12) Patent Application Publication
(10) Pub. No.: US 2013/0230311 A1
(43) Pub. Date: Sep. 5, 2013

(54) Systems and methods for compensating for interference in multimode optical fiber

(71) Applicants: Neng Bai, Orlando, FL (US); Guifang Li, Orlando, FL (US)

(72) Inventors: Neng Bai, Orlando, FL (US); Guifang Li, Orlando, FL (US)

(21) Appl. No.: 13/573,700

(22) Filed: Oct. 3, 2012

Related U.S. Application Data
(60) Provisional application No. 61/606,098, filed on Mar. 2, 2012.

(51) Int. Cl. H04B 10/2507

(52) U.S. Cl. CPC H04B 10/2507
USPC 398/9

(57) ABSTRACT

In one embodiment, compensating for interference in optical fiber relates to receiving a signal transmitted over the optical fiber, multiplying the signal by a frequency domain equalization (FDE) filter that compensates for the interference to obtain a filtered signal, computing an error in the filtered signal, estimating a gradient based upon the computed error, and updating the FDE filter using the estimated gradient.

### CROSS-REFERENCE TO RELATED APPLICATION(S)

This application claims priority to co-pending U.S. Provisional Application Ser. No. 61/606,098, filed Mar. 2, 2012, which is hereby incorporated by reference herein in its entirety.

### BACKGROUND

The exponential growth of the Internet requires a dramatic increase of capacity of optical fiber communication systems. However, the capacity of conventional optical transmission systems based on the single-mode fiber (SMF) has almost reached the nonlinear Shannon limit. To further increase the capacity, few-mode fiber (FMF) transmission systems have been proposed. With a much larger effective area, nonlinear impairments in FMF transmission systems are reduced in comparison with SMF transmission, enabling higher-capacity for long-haul transmission.

Recently, long-haul transmission in the fundamental mode of a FMF has proven to be feasible. This approach can be called fundamental mode operation (FMO) of FMF transmission. Due to the multimode nature of FMF, one of the main impairments of FMO is multi-path interference (MPI). To reduce MPI, several optical solutions have been proposed and demonstrated. Center launch into the FMF has been shown to be able to selectively excite fundamental mode. Also, the FMF can be designed to support only two mode groups and provide a large enough effective index difference between the two mode groups to suppress inter-mode coupling. However, those constraints on FMF design eventually limit the effective area of FMF.

To achieve ultra-high capacity beyond the nonlinear Shannon limit of the single-mode transmission, mode-division multiplexed transmission (MDM) in FMF or multimode fiber (MMF) is rapidly gaining attraction. Ideally, a MDM system can increase the capacity by a factor of the number of modes. Moreover, FMF/MMF has much larger effective area and lower nonlinearity which further improve the capacity of the system. On the other hand, linear impairments such as differential mode group delay (DMGD) and mode coupling severely impact the transmission performance. To compensate/mitigate those impairments, multiple-input multiple-output (MIMO) equalization is required. The computational complexity of the equalizer grows as the DMGD increases. In order to make long-distance FMF/MMF MDM transmission with large DMGD practical, the complexity of the equalizer has to be manageable. So far, adaptive time-domain equalization (TDE) with data-aided least mean squared (DA-LMS) algorithm has been applied in most of reported single-carrier transmission experiments. However, the computational complexity of TDE depends linearly on the total DMGD of the link which makes TDE unfeasible for long-haul MDM transmission.

From the above discussion, it can be appreciated that it would be desirable to have an alternative means for overcoming interference in long-haul transmissions using FMF or MMF.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure may be better understood with reference to the following figures. Matching reference numerals designate corresponding parts throughout the figures, which are not necessarily drawn to scale.

FIG. 1 is an embodiment of an optical communication system that incorporates frequency-domain equalization.

FIG. 2 is a block diagram of a first embodiment of a frequency-domain equalization system that can be incorporated into an optical communication system.

FIGS. 3A and 3B together comprise a flow diagram of an embodiment of a method for performing frequency-domain equalization.

FIG. 4 is a block diagram of a second embodiment of a frequency-domain equalization system that can be incorporated into an optical communication system.

FIG. 5 is a block diagram of a third embodiment of a frequency-domain equalization system that can be incorporated into an optical communication system.

FIG. 6 is a block diagram of a fourth embodiment of a frequency-domain equalization system that can be incorporated into an optical communication system.

FIGS. 7A and 7B are graphs that plot Q² factor versus the number of total filter taps, and the magnitude of sub-filter tap weights for a 30×100 km few-mode fiber transmission link, respectively.

FIG. 8 is a graph that plots Q² factor versus optical signal-to-noise ratio.

FIG. 9 comprises a graph that plots Q² factor versus distance, and constellation diagrams for two Q² values.

FIG. 10 is a graph that plots the impulse response of a center core of a few-mode fiber at 1550 nm.

FIG. 11 is a block diagram of an experimental transmission setup that was used in testing.

FIG. 12 comprises a graph that plots Q² versus optical signal-to-noise ratio, and constellation diagrams for two Q² values.

FIG. 13 is a graph that plots typical sub-filter (odd) tap weights for frequency-domain equalization.

FIG. 14 is a schematic view of a simulation system with frequency-domain equalization tested in a mode-division multiplexing (MDM) context.

FIG. 15 is a graph that plots the Q² factor versus link distance.

FIG. 16 is a graph that plots complexity versus distance.

FIG. 17 includes graphs that plot the magnitude of even frequency-domain equalization in the time domain for two-span transmission.

FIG. 18 is a graph that plots Q² versus angular frequency of mode rotation.

### DETAILED DESCRIPTION

As described above, it would be desirable to have alternative means for overcoming interference associated with long-haul optical fiber transmission. Disclosed herein are systems and methods for compensating for such interference using digital signal processing. The systems and methods employ adaptive frequency-domain equalization (FDE), which significantly reduces computational complexity compared to time-domain equalization (TDE) approaches while maintaining the same performance. As will be apparent from the disclosure that follows, the FDE approach enables greater flexibility in fiber design to allow utilization of a larger number of modes and thus larger effective areas.

In the following disclosure, various specific embodiments are described. It is to be understood that those embodiments are example implementations of the disclosed inventions and that alternative embodiments are possible. All such embodiments are intended to fall within the scope of this disclosure.

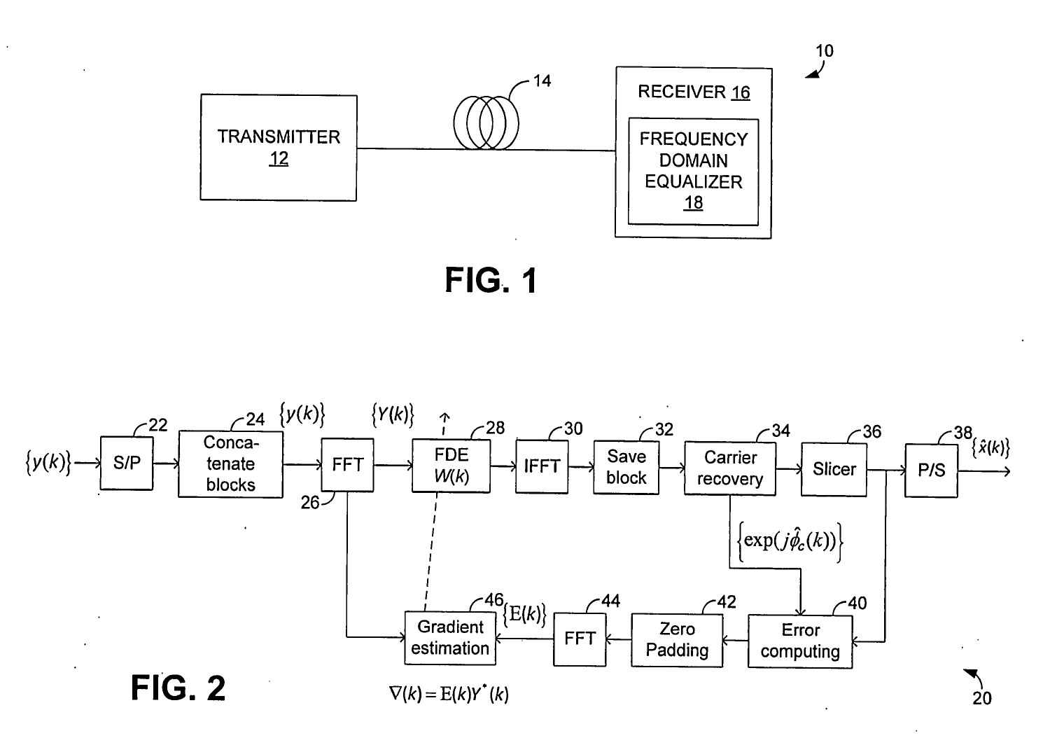

FIG. 1 illustrates an example optical communication system 10 that incorporates adaptive FDE to overcome MPI. As shown in that figure, the system 10 comprises a transmitter 12, a receiver 14, and an optical fiber 16, which can, for example, comprise few-mode fiber (FMF). As used herein, the term “few-mode fiber” refers to optical fibers that support more than one spatial mode but fewer spatial modes than conventional multi-mode fibers. In some embodiments, few-mode fibers support only 2 to 7 spatial modes. The transmitter 12 can comprise any transmitter that can transmit optical signals along the fiber 16, and the receiver 14 can comprise any receiver that can receive and interpret those transmitted signals. By way of example, the transmitter 12 comprises a laser with an external modulator that can be used to excite one or more modes of the fiber 16. As is shown in FIG. 1, the receiver 14 comprises a frequency-domain equalizer 18 that is configured to perform FDE. Example frequency-domain equalizers, or FDE systems are described below in relation to FIGS. 2-6.

FIG. 2 illustrates a first embodiment of an FDE system 20 that can be used in an optical communication system, such as the system 10 of FIG. 1. For this embodiment, it is assumed that the few-mode fiber of the optical communication system is used in fundamental mode operation (FMO) such that only the fundamental mode of the fiber is used. The FDE system 20 of FIG. 2 can be formed from one or more circuits. In some embodiments, the system 20 comprises multiple application-specific integrated circuits (ASICs) (i.e., logic) that are specifically configured to perform the discrete functions that are described below. In other embodiments, those functions can be embodied in software executed by a processor.

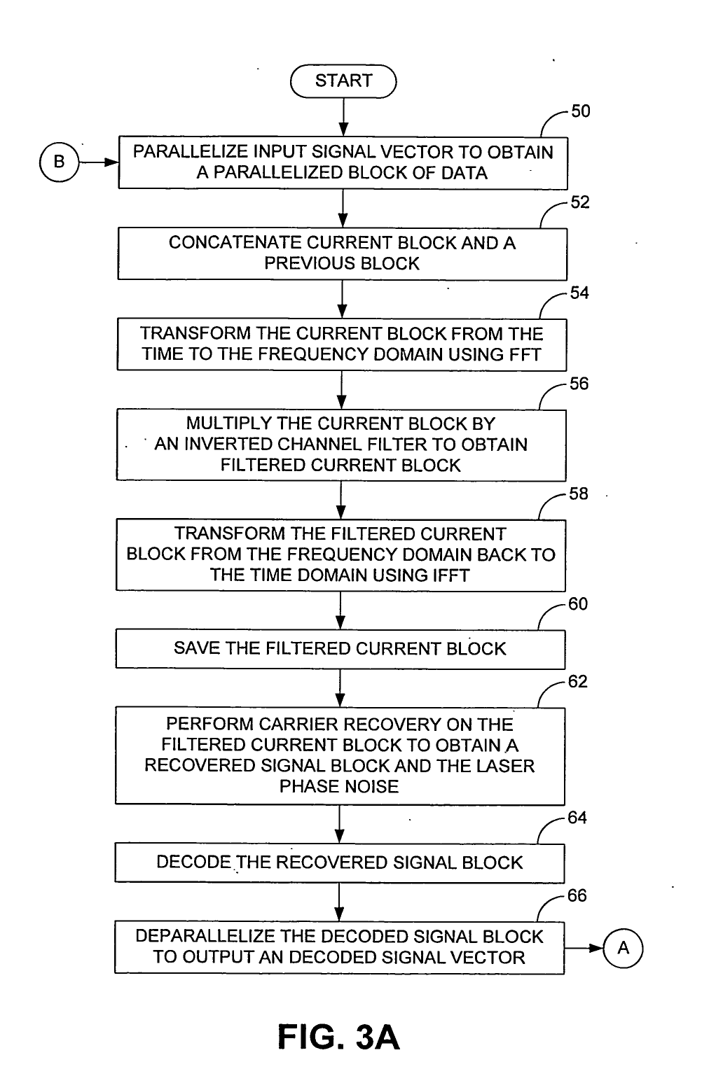

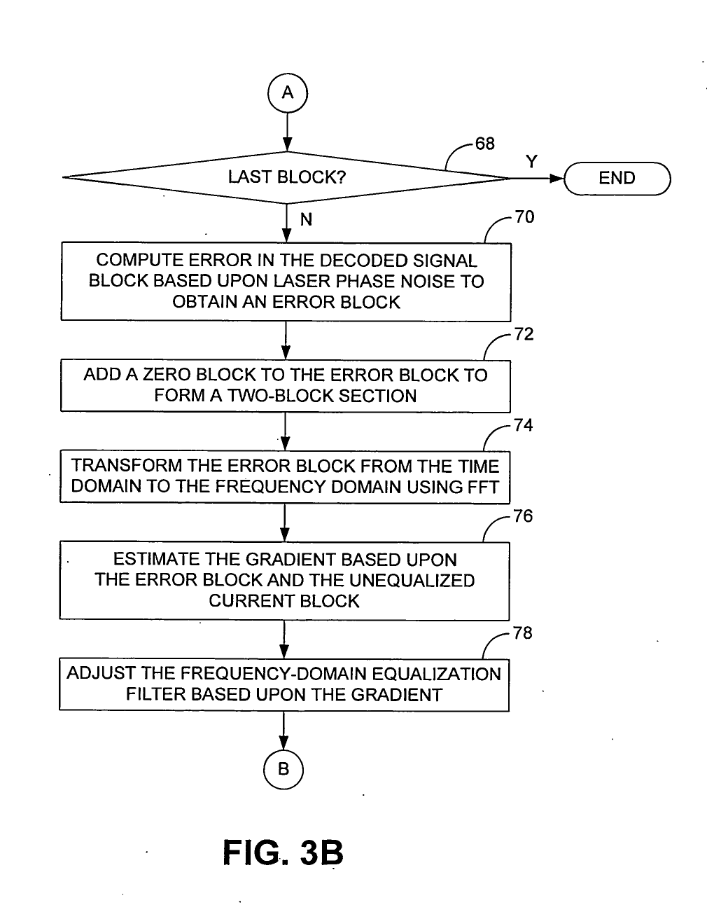

Operation of the system 20 will be discussed with regard to both FIG. 2 and the flow diagram of FIGS. 3A and 3B. An input signal vector {y(k)} that is obtained after coherent receiving a signal transmitted from a transmitter is first parallelized using a serial-to-parallel module to obtain a parallelized block of data, as indicated in block 22 of FIG. 2 and block 50 of FIG. 3A. For purposes of this discussion, the parallelized block of data can be considered to be the “current” block of data, also referred to as the “current block,” in the frequency-domain equalization process.

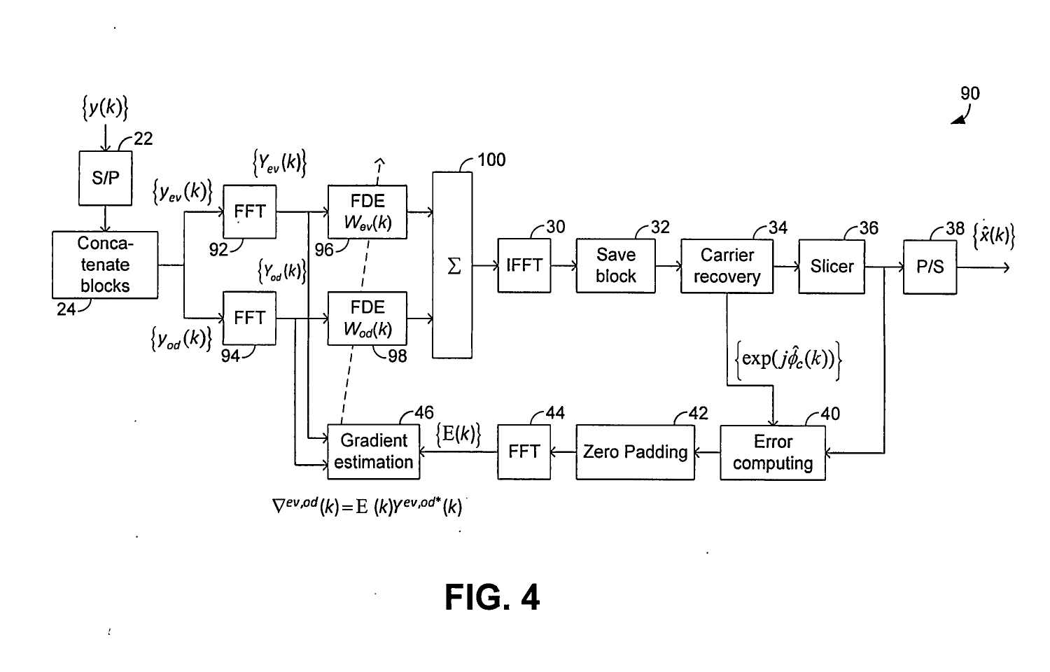

The current block can then be transformed from the time domain into the digital domain. In some embodiments, this transformation is performed using fast Fourier transformation (FFT). In order to perform linear convolution between signal vector and the filter in frequency domain, overlap-and-save method is used. The overlap rate can be set to optimal to minimize the overall complexity of the algorithm. For simplicity of implementation, 0.5 overlap rate is used in FIG. 4-6. The current block is first concatenated with a previous block, as indicated in block 24 of FIGS. 2 and 52 of FIG. 3A, to obtain a larger block. In this context, the “previous block” is the former current block that was processed in the frequency-domain equalization, which is performed in a continuous loop. In the case in which the current block is the first block to be processed, the previous block can be presumed to be a zero block of data.

Once the two blocks have been concatenated, FFT can be performed to transform the current block from the time domain into the frequency domain, as indicated at block 26 of FIG. 2 and block 54 of FIG. 3A. At this point, the current block, {Y(k)}, is multiplied by an FDE filter W(k), as indicated at block 28 of FIG. 2 and block 56 of FIG. 3A, to compensate for the MPI that results from the physical characteristics of the optical fiber. Through this process, a filtered current block is obtained. As is apparent from the disclosure that follows, the FDE filter W(k) is continually updated by the system 20 because MPI is a time-variant phenomenon. According to calculated incremental adjustments from gradient estimation, FDE filter weights are updated from the initial guess values toward the optimum after a stochastic adaptation process. A gradient constraint condition is applied to enforce an accurate calculation of linear convolution. The error signal calculation depends on what type of equalization algorithm is selected. In some embodiments, a constant modulus algorithm (CMA) is used and weights of the filter are updated at the symbol rate.

The updating rule of FDE filter weights can be expressed as:

ΔW_{pq}(k)=μ∇_{pq}(k) [Equation 1]

where ΔW_{pq}(k) represents adjustment of the weight of filter coefficients located at the pth row and the qth column of the filter matrix, μ denotes the step size of the adjustment, and ∇_{pq}(k) is the gradient. The gradient can be expressed as:

∇_{pq}(k)=Eₚ(k)Y_{q}*(k) [Equation 2]

where Eₚ(k) is the error from the pth mode channel in the frequency domain and Y_{q}(k) is the conjugated signal from the qth mode channel in the frequency domain. Since Y_{q}^{e,o}(k) is contaminated by the laser phase noise, to compute the gradient without the impact of the phase noise, the error block is multiplied by an estimated phase fluctuation exp(j\hat{φ}ₚ(k)) in the time domain:

eₚ(k)=(dₚ(k)−\hat{x}ₚ(k))exp(j\hat{φ}ₚ(k)) [Equation 3]

where dₚ(k) denotes the training symbol from the pth mode channel and \hat{x}ₚ(k) represents the output signal from the pth mode channel at the output of adaptive filter. By doing so, the phase fluctuation factor in (Y_{q}^{e,o}(k))* can be canceled in Equation (2) enabling phase noise insensitive gradient estimation.

In the above discussion, the phase noise \hat{φ}ₚ(k) for each mode channel is recovered independently. However, in transmission systems where a single transmitter laser and a single local oscillator laser are commonly used for all the spatial/polarization modes, the phase fluctuation of one mode channel are approximately the same as the phase fluctuation of the other modes with some time delays. Therefore, a master-slave phase estimation (MSPE) scheme can be applied in the receiver DSP. In the scheme, the phase noise is extracted from only one mode channel and used to recover phases of all channels. The MSPE scheme reduces complexity of the PE process by the number of used mode channels, as compared to the conventional PE algorithms without MSPE.

In a practical environment, the speed of temporal variation of the mode coupling characteristics in the fiber may be much lower than the symbol rate. Therefore, temporal variations of mode coupling can be tracked via the adaptive equalization. In contrast to TDE, calculation such as correlation and convolution can be simplified to be multiplication in FDE.

Returning to the figures, the filtered current block can next be transformed back to the time domain using inverse FFT (IFFT), as indicated at block 30 of FIG. 2 and block 58 of FIG. 3A. The filtered current block is saved (block 32, FIG. 2; block 60, FIG. 3A), and carrier recovery (CR) can be performed to obtain both a recovered signal block and the phase noise of the laser that was used to transmit the original signal, as indicated in 34 of FIG. 2 and block 62 of FIG. 3A. As is indicated in FIG. 2, the laser phase noise {exp(j\hat{φ}_{c}(k))} is provided as an input to an error computing module 40, which is described below.

With further reference to FIG. 2, the recovered signal block is delivered to a slicer 36, which decodes the recovered block to convert the block from an analog signal to a digital signal, as is also indicated in block 64 of FIG. 3A. At this point, the decoded signal block is serialized using a parallel-to-serial module, and the output signal vector {\hat{x}(k)} is obtained, as indicated at block 38 of FIG. 2 and block 66 of FIG. 3A.

Referring next to decision block 68 of FIG. 3B, flow from this point depends upon whether or not the current block is the last block of data in the transmission. If so, flow for the session is terminated. If not, however, flow continues and the FDE filter W(k) is updated for use on the next block of data. As indicated in block 40 of FIG. 2 and block 70 of FIG. 3B, the error in the decoded signal that is output from the slicer is computed to obtain an error block {E(k)}. The error in the signal can be computed using various methods. In one embodiment, the error is computed using a constant modulus algorithm with which the intensity of the decoded signal is compared with the expected intensity. In this case, the error is the deviation from the expected intensity. In other embodiments, the error can be computed using a data-aided least mean squares method or a decision-directed least mean squares method.

Once the error block has been computed, FFT can be performed to transform it from the time domain into the frequency domain. Because the error block is only a single block of data and because a two-block section is needed to perform the filter updating, a zero block is added to the error block to form a two-block section that is suitable for the filter updating process, as indicated in block 42 of FIG. 2 and block 72 of FIG. 3B.

Once FFT has been performed (block 44, FIG. 2; block 74, FIG. 3B), the gradient ∇_{pq}(k) is estimated, as indicated in block 76 of FIG. 3B. As is apparent from FIG. 2, the gradient estimation module 46 receives as inputs the unfiltered current block in the frequency domain {Y(k)} and the error block {E(k)}.

Once the gradient has been estimated, the FDE filter W(k) can be adjusted, as indicated in block 78 of FIG. 3B (and by the dashed arrow in FIG. 2), so that it can be applied to the next block of data (i.e., the new current block). Flow can then return to block 50 of FIG. 3A and the actions described above can be repeated for the new current block.

FIG. 4 illustrates a second embodiment of an FDE system 90. The system 90 is similar in many ways to the system 20 shown in FIG. 2. In the system 90, however, the input signal vector {y(k)} is divided into even and odd vectors {yₑᵥ(k)} and {y_{od}(k)} to process the input signal vector at a rate of two samples per symbol. In such a case, two FFT modules 92 and 94 are used and two subfilters Wₑᵥ(k) and W_{od}(k) (96 and 98 in FIG. 4) are applied to the even and odd branches, respectively. After filtering, the even and odd branches are brought back together using a summation module 100.

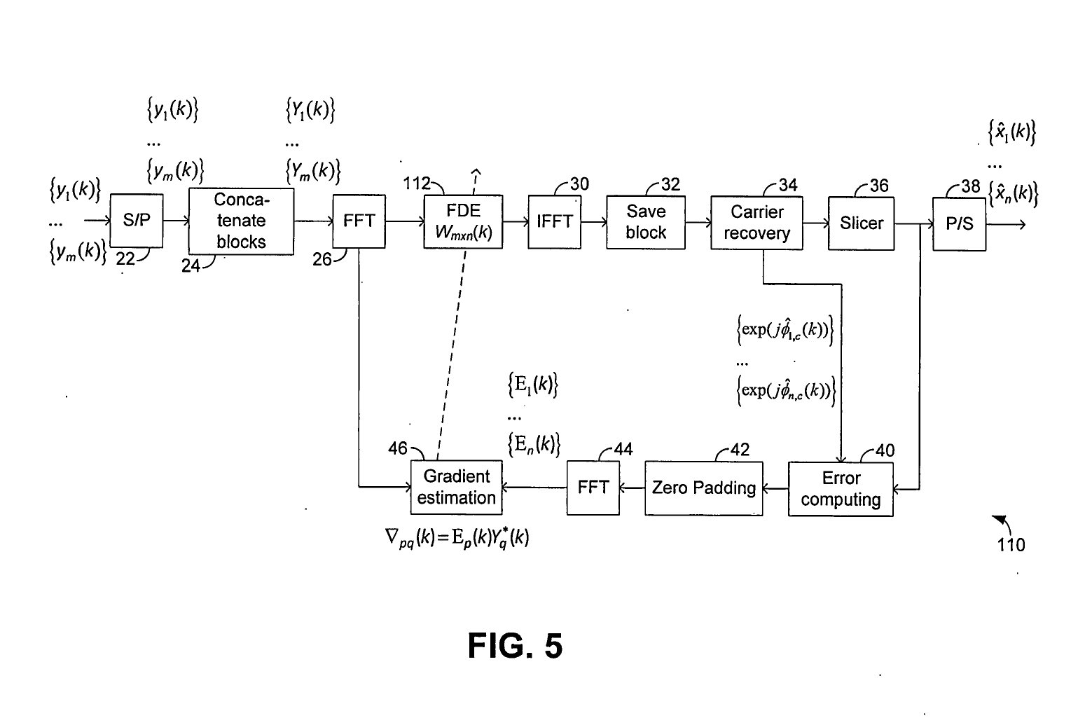

Mode-division multiplexed transmission (MDM) can increase a fiber's capacity by a factor of the number of modes. However, linear impairments such as differential mode group delay (DMGD) and mode coupling severely impact the transmission performance. To compensate/mitigate those impairments, multiple-input multiple-output (MIMO) equalization is required. FIG. 5 illustrates a third embodiment of an FDE system 110 that can be used in cases in which the FMF of the optical communication system is used in a MIMO scheme such that multiple modes of the fiber are used instead of only the fundamental mode. In such a case, multiple input signal vectors {y₁(k) . . . yₘ(k)} are received, the filter matrix W̅_{m×n}(k) (block 112 in FIG. 5) is applied, and multiple output signal vectors {\hat{x}₁(k) . . . \hat{x}ₙ(k)} are obtained.

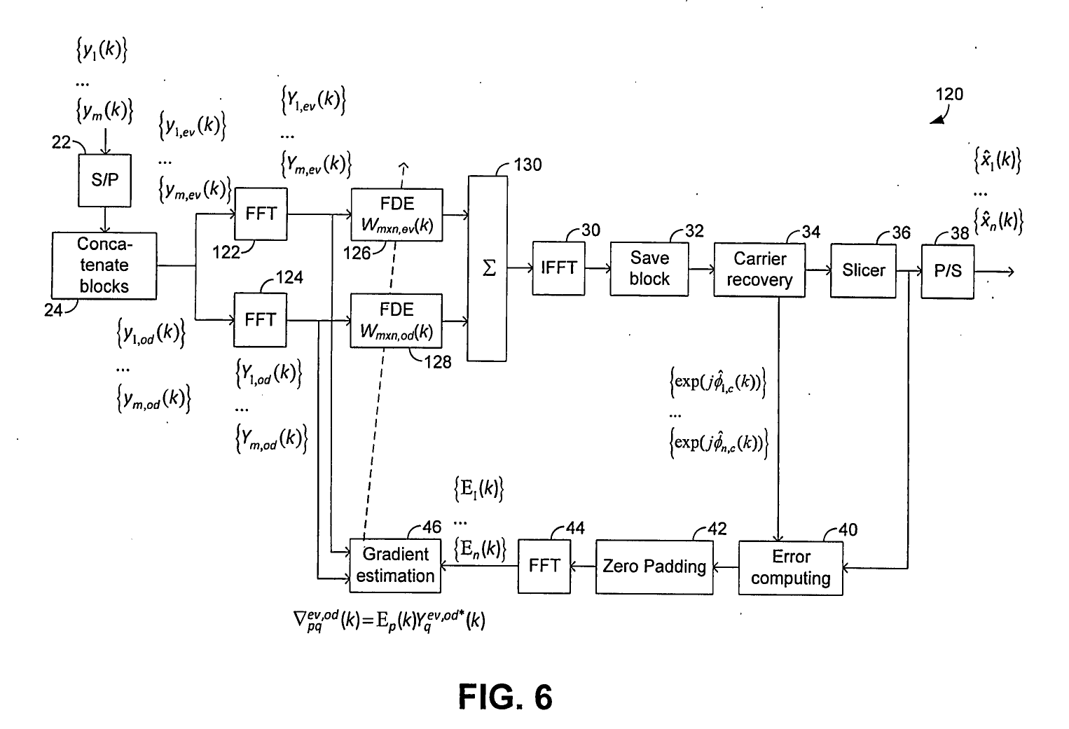

FIG. 6 illustrates a fourth embodiment of an FDE system 120. The system 120 is similar to the system 110 shown in FIG. 5, but the input signal vectors {y₁(k) . . . yₘ(k)} are divided into even and odd vectors {y_{1,ev}(k) . . . y_{m,ev}(k)} and {y_{1,od}(k) . . . y_{m,od}(k)}. In such a case, two FFT modules 122 and 124 are used and two subfilters W_{m×n,ev}(k) and W̅_{m×n,od} (126 and 128 in FIG. 4) are applied to the even and odd branches, respectively. After filtering, the even and odd branches are brought back together in a summation module 130.

A long-distance FMF transmission with a span length of 100 km was simulated to evaluate the performance of FDE in long-haul FMF transmission systems. Without loss of generality, a linear two-mode propagation model was used. The random distributed mode coupling through the FMF was taken into account in the model by multiplying a unitary rotation matrix at the end of every fiber section whose length equaled the coherent length L_{c} of the FMF (L_{c}=1 km in the model). The mode scattering factor σ represents the strength of inter-mode coupling. In the simulation, σ was chosen to be 30 dB/km to demonstrate the capability of MPI cancelation using FDE. The loss and dispersion coefficient for both modes were 0.2 dB/km and 18 ps/nm/km respectively. The differential modal group delay (DMGD) was chosen to be 27 ps/km. The inline amplifier was assumed to compensate loss of the LP₀₁ mode while LP₁₁ mode received no modal gain. The noise figure of the amplifier was set to be 5 dB. No fundamental mode filter was applied either in the middle of each span or in front of the amplifier. Mode coupling was assumed to be only contributed by distributed mode coupling. Splicing-induced mode coupling or loss was neglected based on previous experimental results. A quadrature phase shift keying (QPSK) coherent transmission system with 28 Gbaud/s symbol rate was simulated.

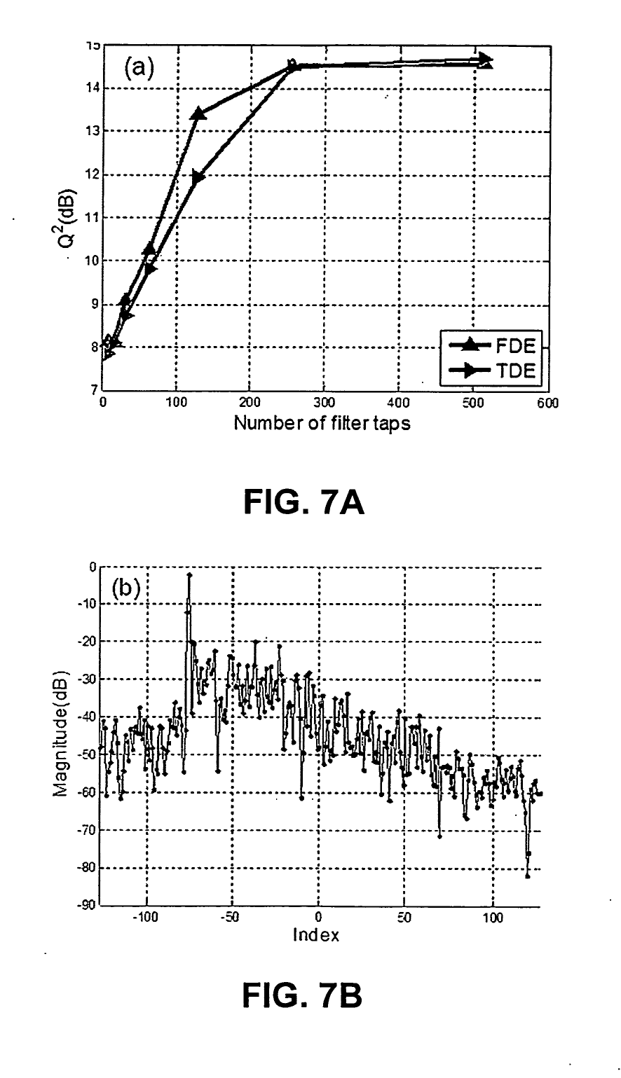

For multi-span FMF transmission, the total DMGD of the link is multiple times of single span. In MDM transmission, the tap length of the equalizer should exceed the total DMGD requiring thousands of taps. In the context of FMO transmission, the relation between required length of equalizer and DMGD was first studied. FIG. 7A plots Q² factor as a function of equalizer tap length for a 30×100 km transmission at an optical signal-to-noise ratio (OSNR) of 17 dB. The tap number was chosen to be power of 2 for the sake of ease of FFT. The Q² factor started to converge when the tap number increased to 256. This filter length in time (4.6 ns) was just slightly larger than single span DMGD (2.7 ns) but much smaller than the total DMGD of the link (810 ns).

The above results suggest that, for FMO transmission, the minimum required filter length equals single span DMGD but not the total DMGD of the link. It is straightforward to understand this phenomenon from the nature of MPI. For simplicity, the mode coupling process is assumed to be modeled as collection of discrete random coupling events with separation distance equal to the coherent length of the fiber. For a two-mode fiber, the path of a MPI signal is of the form “LP₀₁→LP₁₁→ . . . LP₀₁,” with an even number of coupling events. Since the mode scattering factor is normally very small, the MPI induced by more than two coupling events are negligible. If only the “LP₀₁→LP₁₁→LP₀₁” case is considered, the relative delay between MPI components and the main signal which stays in LP₀₁ depends on the distance between two coupling locations. During the section between couplings, the MPI component propagates in the LP₁₁ mode. If the coupling distance is larger than the span length, the interference signal goes through an amplifier in the LP₁₁ mode, which has zero modal gain. Therefore, only MPI components with a pair of couplings inside a single span could survive at the end of the link. Indeed, the assumption is verified also as shown in FIG. 7B, which plots filter weights of a sub-filter for the odd samples. A magnitude less than −30 dB is observed for those taps with index larger than 0. This indicates that the intensity of MPI with group delay larger than the DMGD of a single span is infinitesimal.

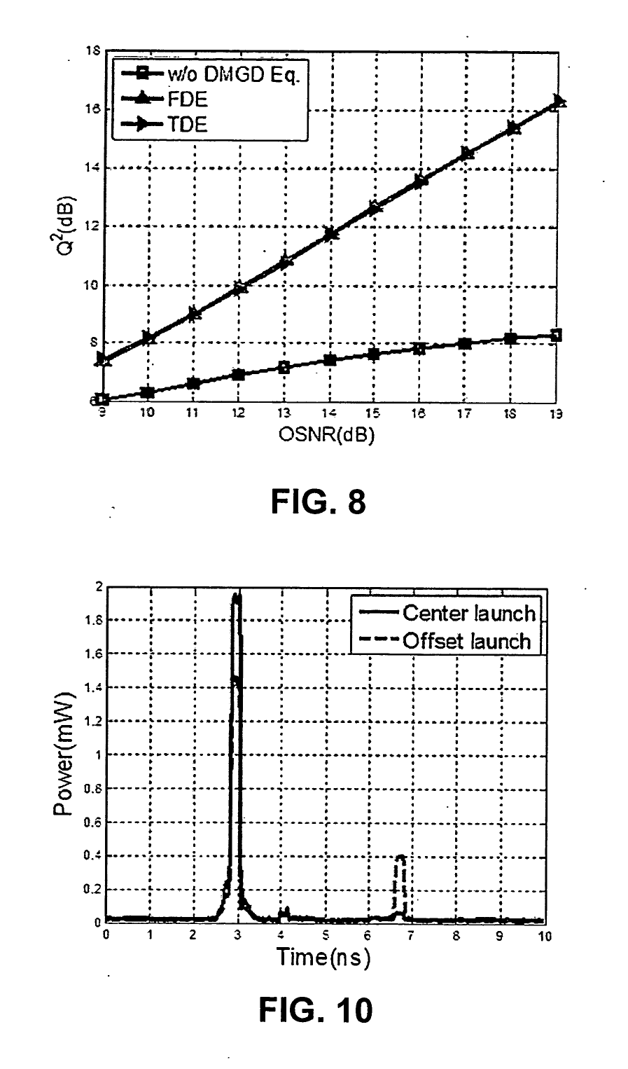

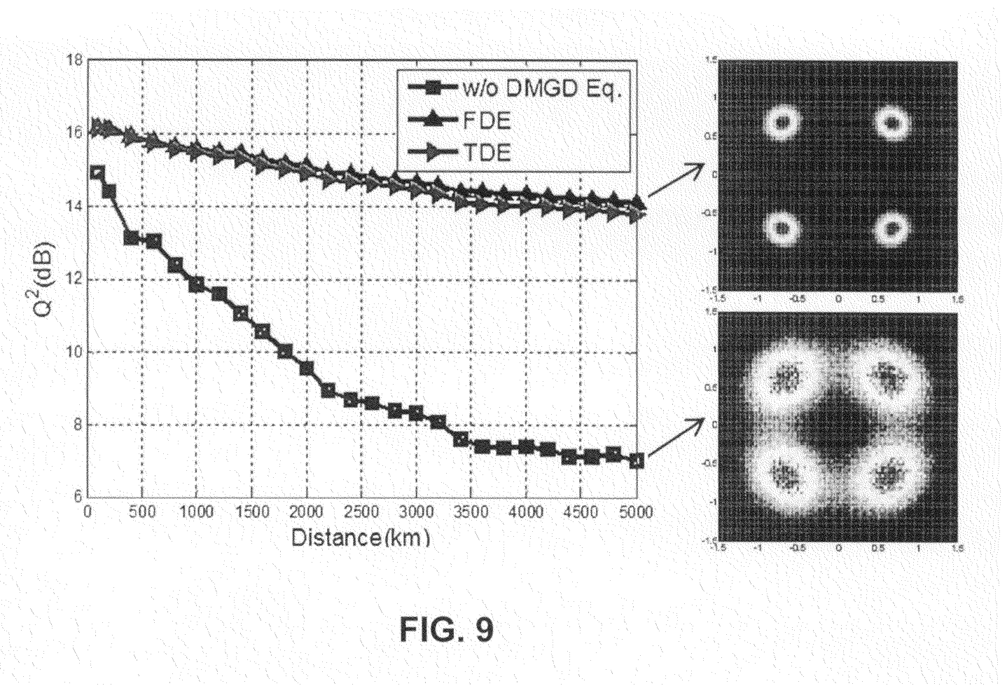

Long-haul transmission simulation results are shown in FIGS. 8 and 9. Simulations for 30×100 km transmission at different OSNR levels were performed. FIG. 8 illustrates the result curve. The performance improvement due to adaptive DMGD/MPI equalization grows as OSNR increases, as shown in FIG. 8. FIG. 9 demonstrates Q² factor as a function of distance ranging from 100 km to 5,000 km. Noise loading at the receiver was used to fix the OSNR at 17 dB. Without DMGD equalization, system performance degrades rapidly as the transmission distance increases due to accumulated MPI. With equalization, the performance increases as much as 7 dB in terms of Q² factor. For all distances, both TDE and FDE have a total of 256 taps. At the same performance, FDE saves 88.7% computational load as compared to TDE.

In testing, a one kilometer, step-index FMF with a core diameter of 13.1 μm was used to experimentally demonstrate FDE. The FMF effectively guided two spatial mode groups, LP₀₁ and LP₁₁ at 1550 nm. The effective area of the fiber was 113 μm². Although only single-span transmission was performed, multi-span transmission can be compensated using equalizer with the same filter length as that for a single span.

The fiber was first characterized by measuring the impulse response, which is shown in FIG. 10. A pulse train at a repetition period of 8 ns was generated by modulating the amplitude of the continuous wave (CW) light from an external cavity laser (ECL). The pulse width was 200 ps. The pulsed light was then butt-coupled from a single mode fiber (SMF) into the FMF. After one kilometer transmission, the output light was coupled back into a SMF, which was connected with a sampling oscilloscope. When the position of the SMF at the excitation stage was aligned with the center of the FMF, only one pulse was found in the period. Due to the short distance, the temporal spread of the pulse from chromatic dispersion (CD) was fairly small. When the SMF was offset by a few microns from the center, a weak replicate pulse started to grow due to the excitation of the LP₁₁ mode. It should be noted that the modal effective index difference between LP₀₁ and LP₁₁ is about 2×10⁻³, which is large enough to suppress intra-core mode coupling. The low-mode coupling can be verified in the impulse response where the power level between two distinct pulses is very low. The weak hump between two pulses is caused by imperfect frequency response of the modulator driver. In addition, the DMGD can be estimated by measuring the temporal separation between the two pulses. At 1550 nm, the DMGD is about 3780 ps for 1 km fiber which is approximately equal to a 140 km span of FMF used in the mode-division multiplexing experiment.

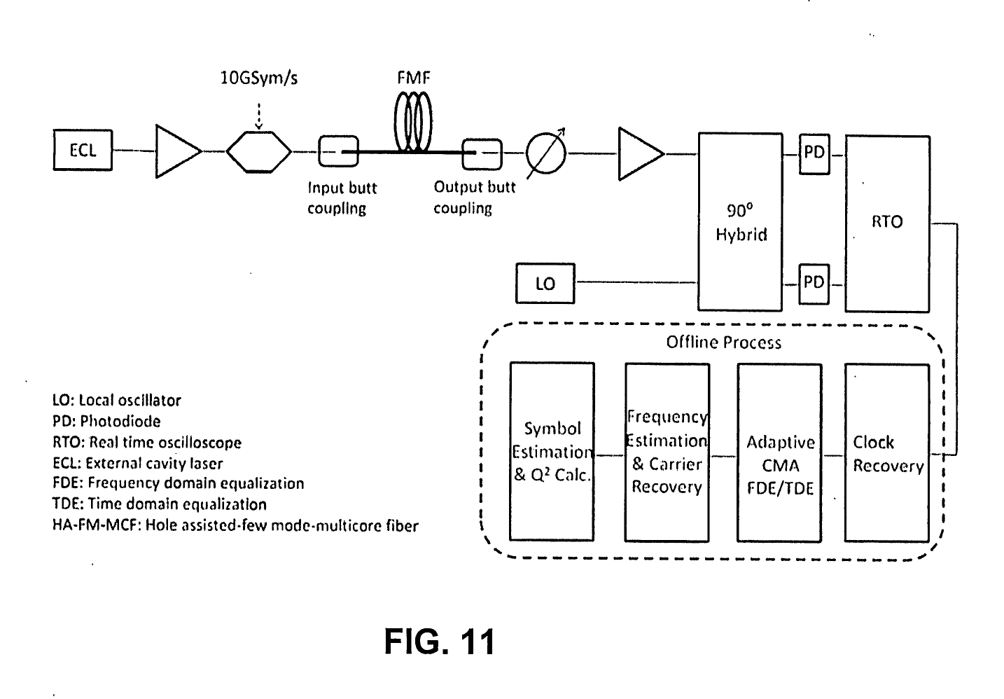

The transmission experimental setup is illustrated in FIG. 11. A 10 Gs/s binary phase shift keyed (BPSK) signal was generated by using an amplitude modulator and a pattern generator. Both ends of the FMF were butt-coupled with SMFs, in the same way as in the impulse response measurement. A high precision variable attenuator and a post-amplifier were used to adjust the OSNR at the coherent receiver. The signal was then sent to a 90 degree hybrid followed by two photo-detectors measuring the real and imaginary parts of the complex signal. Finally, the electric waveforms were fed into a real-time oscilloscope with a 40 GHz sampling rate. 5×10⁵ samples were then recorded and processed offline.

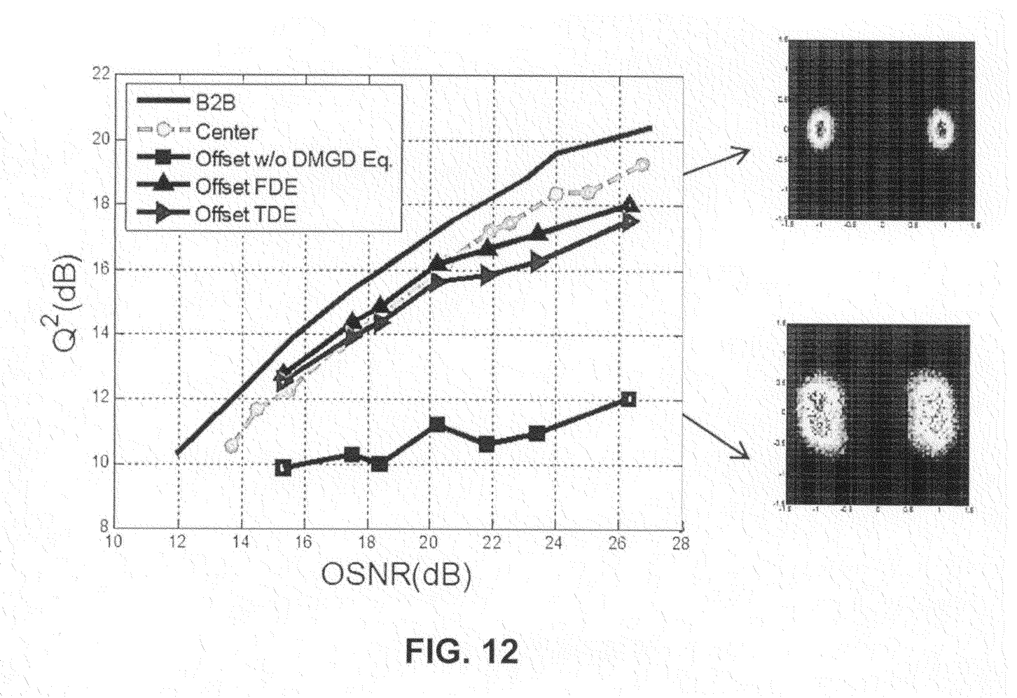

Because of the relatively short transmission distance and low inter-mode coupling, distributed mode coupling was negligible in the fiber. To emulate multipath interference, the SMF was intentionally offset several microns to excite both the LP₀₁ and the LP₁₁ modes. The offset launch condition is equivalent to a discrete mode coupling at the beginning of the FMF. At the output end of FMF, the FMF-SMF butt-coupling was also misaligned to receive powers from both the LP₀₁ and LP₁₁ modes. In offline digital signal processing, both adaptive TDE and FDE were applied after clock recovery to compare the performance, as well as efficiency, of these two approaches. In order to compensate DMGD, the equalizers with a total tap length of 128 were used for both TDE and FDE. FIG. 12 shows Q² factor as a function of OSNR at the receiver. For back-to-back measurements, center launch and offset launch without DMGD equalization, only a 16 taps adaptive finite impulse response (FIR) filter was applied to equalize the CD or other impairments such as the frequency response of modulator driver and real time oscilloscope (RTO). Due to MPI, offset launch suffered a high penalty compared to center launch case. At low OSNR, the performance of offset launching with equalization is approximately equal to center launching, which verifies that both TDE and FDE effectively reduced the impact of MPI. Moreover, the computational complexity of FDE is only 20% of TDE.

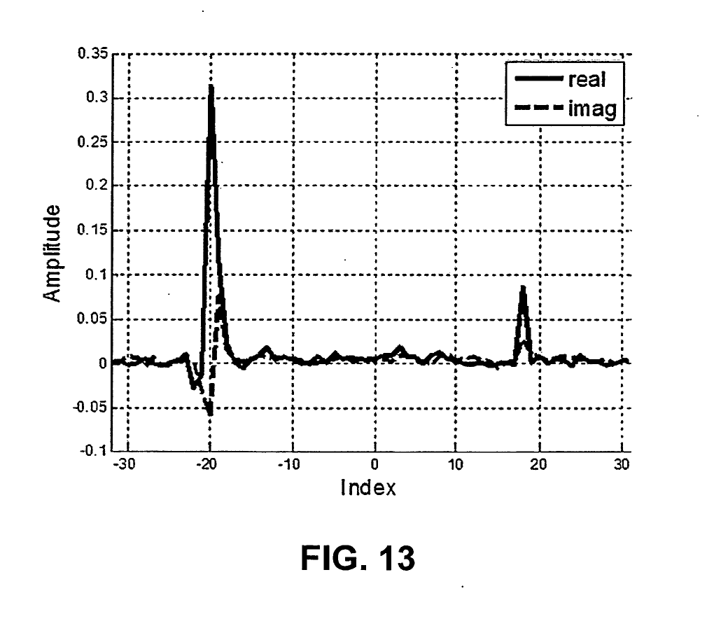

In FIG. 13, the complex values of frequency domain sub-filter tap weights are plotted in the time domain. It can be observed that two distinct peaks occurred, which correspond with the impulse response measured in FIG. 10 under offset launching condition. The left main peak corresponds to the signal launched into LP₀₁ mode, while the right weak peak corresponds to signal coupled to LP₁₁ mode, at the beginning of the fiber. Two signal components propagate at different group velocities. The temporal separation between two dominant peaks (˜3800 ps) is close to the DMGD that was previously measured.

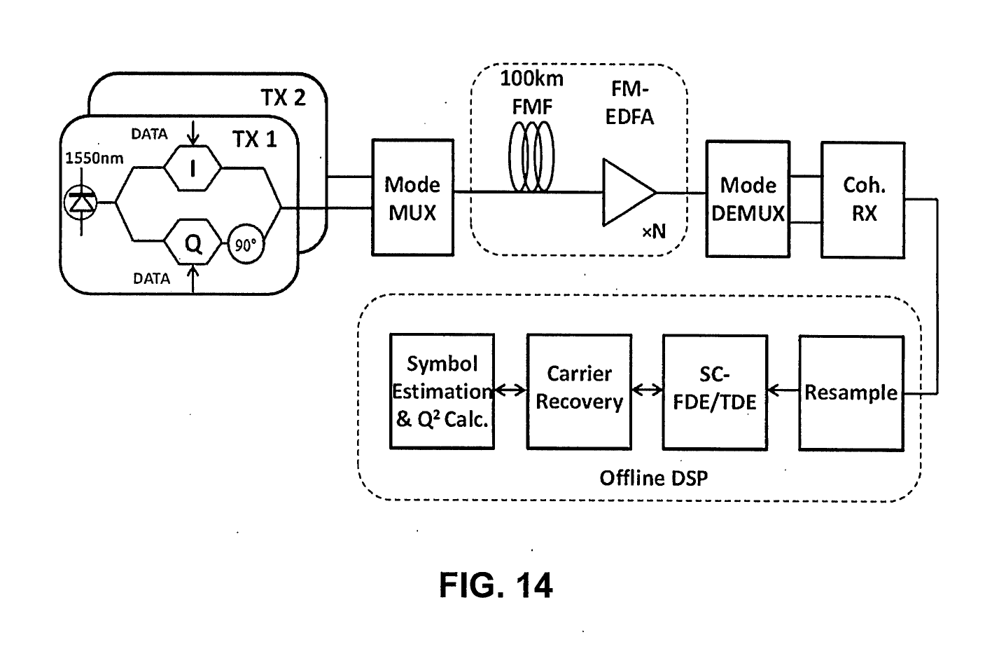

Simulations were also performed to verify the effectiveness of single-carrier frequency-domain equalization (SC-FDE) in a mode-division multiplexed (MDM) transmission scheme. FIG. 14 shows the configuration of the simulated link. Without loss of generality, the transmission FMF supports only two modes, LP₀₁ and LP₁₁. At the transmitter, two CW lasers with a 100 kHz line-width operating at 1550 nm were separately modulated by two 28 GBaud QPSK signals that were combined and coupled to the FMF by a mode-multiplexer (MUX). The fiber link included N span of 100 km FMF and N FM-EDFAs with a noise figure of 5 dB to compensate span losses for both modes. At the receiver, a mode-demultiplexer (DEMUX) extracted two mode channels, which were fed into the coherent receivers. Digital signal processing was then applied on the received data to recover the signals.

A multi-section field propagation model was used to simulate two-mode transmission in FMF. The section length was set to be 1 km. The mode scattering coefficient was set to be −30 dB/km. The loss and dispersion coefficients were 0.2 dB/km and 18 ps/nm/km for both modes. DMGD was set to be 27 ps/km. At both ends of a single span of FMF, a −22 dB inter-mode crosstalk was assumed from mode MUX/DEMUX or splicing.

The received signal was resampled to two samples per symbol. Two signal tributaries then entered the adaptive equalizer. To ensure the best performance, two CR stages were used. One CR stage was inside the adaptive loop applying DA-LMS phase estimation with training sequence and Mth power phase estimation with transmitted data. The other stage was located at the output of the adaptive equalizer for decision directed-LMS phase estimation to further mitigate the laser phase noise. After carrier recovery, hard-decision symbols estimation was followed by Q² factor calculation.

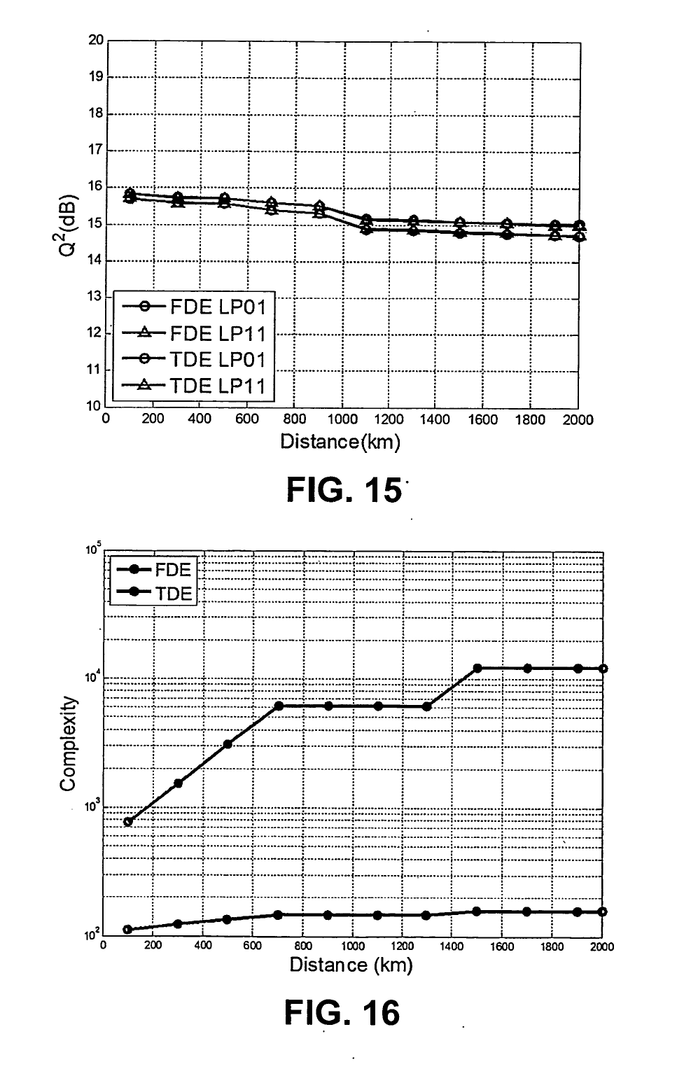

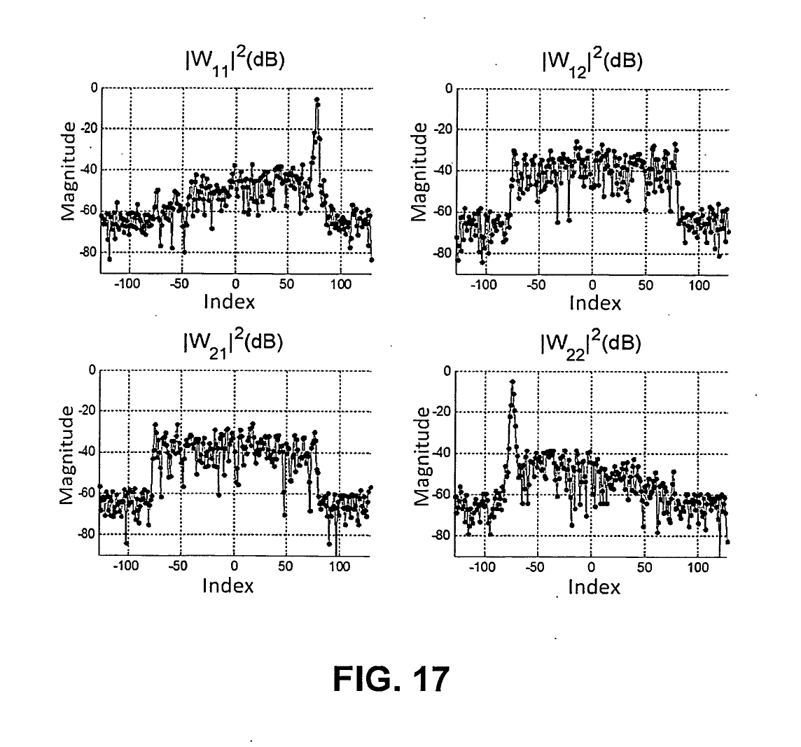

To evaluate the performance of SC-FDE, transmissions with different link distances from 100 km to 2,000 km were simulated. FIG. 15 shows the Q² factor as a function of distance for both FDE and TDE. To make a fair comparison, filter size, convergence step size, and initial conditions were chosen to be the same for both FDE and TDE. The filter length was larger than the total DMGD of the link. The number of filter taps was selected to be an integer power of 2 to facilitate efficient FFT implementation. Before the coherent receivers, variable noise was loaded to ensure a fixed OSNR level of 16 dB for different transmission distances. The first 10⁵ symbols were used as training sequence followed by 9×10⁵ test symbols. According to FIG. 16, both FDE and TDE effectively mitigate inter-mode cross talk and show similar performance. The computational complexity is plotted in FIG. 17.

As the transmission distance grows, the accumulated DMGD increases leading to larger filter sizes. The complexity of FDE increases much slower than TDE due to the fact that the complexity of FDE scales logarithmically with total DMGD instead of linearly. At a transmission distance of 2,000 km, FDE reduces complexity by a factor of as much as 77 compared to TDE.

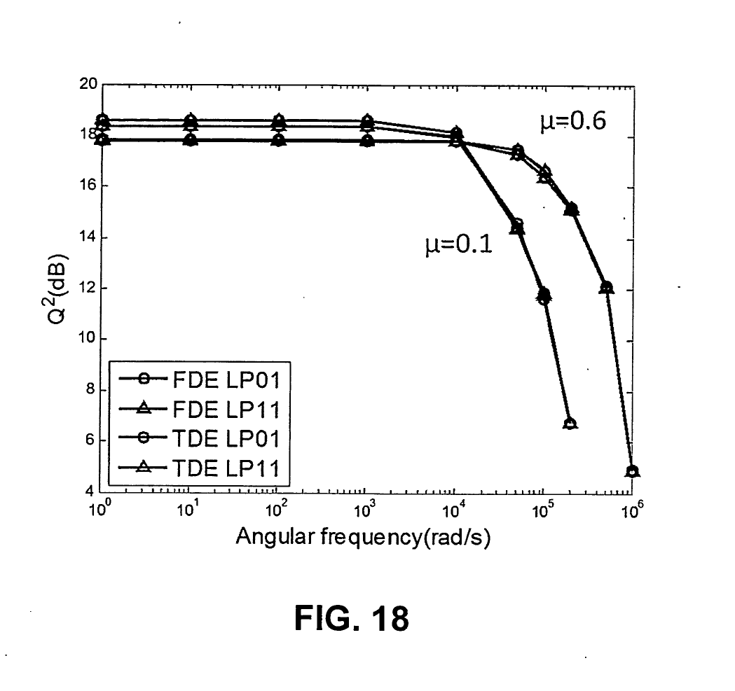

The magnitude of FDE sub-filter coefficients for the even samples in time domain after convergence was plotted in FIG. 18 for 2×100 km MDM transmission. The total DMGD is 5.4 ns and the sub-filter contains 256 taps. Each diagonal filter element compensates multipath interference (MPI) for each mode while each off-diagonal filter element mitigates crosstalk between two mode channels. The dominant peaks in the diagonal filters correspond to original signal. The relative delay between them coincides with DMGD of two spans of FMF. Tap weights in off-diagonal filter form a pedestal shape caused by distributed mode coupling through the fiber.

The simulation results above assumed that mode coupling was static. However, in practice, especially for long-haul transmission, temporal variation of environmental conditions leads to time-variant mode coupling. One of the advantages of an adaptive equalizer is that it can continuously track the temporal variation of the system. To verify the dynamic response of SC-FDE, a mode scrambler was inserted between the FMF and mode DEMUX for single-span transmission. The mode scrambler provided endless mode rotation with a time-dependent rotation matrix of angular frequency Ω.

$${J}_{s} = [ \begin{matrix}cos ( Ω t ) & sin ( Ω t ) \\ - sin ( Ω t ) & cos ( Ω t )\end{matrix} ] \qquad [ Equation 4 ]$$

In FIG. 18, Q² factor is shown as function of the rotation angular frequency for different convergence step size. The sub-filter size is 128 taps for single span transmission. Q² factor maintains constant until variation is too fast to be tracked. The convergence property of the algorithm can be adjusted by tuning μ. The maximum Q² for μ=0.1 is slightly higher than μ=0.6 due to lower mis-adjustment. When μ=0.6, FDE only suffers a 0.4 dB drop from the maximum in terms of Q² factor when mode rotation is operated at 50 krad/s. It should be noted that in a practical environment, the speed as well as coupling strength is much smaller than in this simulation. Besides, FDE shows the same tracking capability as TDE when μ is equal. Although FDE updates in the period of a block, the error signal is permitted to vary at the symbol rate which determines the effective updating rate. Therefore, FDE and TDE have the same convergence property. It should be mentioned that the updating loop for FDE contains operations such as FFT and phase estimation which may slow down the tracking speed. In the simulation, the delay caused by those operations was not included.

From the foregoing disclosure, it can be appreciated that FDE significantly reduces computational complexity, as compared to TDE, while maintaining similar equalizing performance. FDE therefore potentially enables enhanced the transmission capacity using ultra large effective area FMF.

Claimed are:

1. A method for compensating for interference in multimode optical fiber transmission, the method comprising:
receiving a signal transmitted over the multimode optical fiber;
multiplying the signal by a frequency domain equalization (FDE) filter that compensates for the interference in the frequency domain to obtain a filtered signal;
computing an error in the filtered signal;
estimating a gradient based upon the computed error; and
updating the FDE filter using the estimated gradient.

2. The method of claim 1, further comprising repeating the actions of claim 1 in a continuous loop so that the FDE filter is continuously updated and used to compensate for the interference as new signals are received.

3. The method of claim 1, further comprising transforming the signal from the time domain into the frequency domain prior to multiplying the signal by the FDE filter, and transforming the signal back to the time domain after multiplying the signal by the FDE filter.

4. The method of claim 3, further comprising transforming the error from the time domain into the frequency domain prior to estimating the gradient.

5. The method of claim 1, wherein updating the FDE filter comprises adjusting FDE filter weights according to
ΔW_{pq}(k)=μ∇_{pq}(k)
where ΔW_{pq}(k) is an adjustment of the weights of filter coefficients located at a pth row and a qth column of a filter matrix, μ denotes a step size of adjustment, and ∇_{pq}(k) is the gradient.

6. The method of claim 1, wherein computing the error comprises computing the error using a constant modulus algorithm with which the intensity of the filtered signal is compared with the expected intensity.

7. The method of claim 1, wherein estimating a gradient comprises estimating the gradient using the relation
∇_{pq}(k)=Eₚ(k)Y_{q}*(k)
where Eₚ(k) is the error from the pth mode channel in the frequency domain and Y_{q}*(k) is the conjugated signal from the qth mode channel in the frequency domain.

8. The method of claim 1, further comprising performing carrier recovery on the filtered signal to obtain a recovered signal and a laser phase noise associated with a laser that was used to transmit the received signal and wherein the error is calculated based also upon the laser phase noise.

9. The method of claim 1, further comprising performing phase estimation on one mode channel and using estimated phase noise to perform carrier recovery for all the mode channels when a single transmitter laser and a single local oscillator are used for all the mode channels.

10. The method of claim 1, further comprising splitting the received signal into even and odd branches prior to multiplying the signal by an FDE filter, and wherein multiplying the signal by an FDE filter comprises multiplying each branch by its own FDE filter.

11. The method of claim 1, wherein receiving a signal comprises receiving multiple signals transmitted over multiple spatial modes of the optical fiber, and wherein multiplying the signal by an FDE filter comprises multiplying each of the signals by the FDE filter.

12. A system for compensating for interference in multimode optical fiber, the system comprising circuitry configured to:
receive a signal transmitted over the multimode optical fiber;
multiply the signal by a frequency domain equalization (FDE) filter that compensates for the interference in the frequency domain to obtain a filtered signal;
compute an error in the filtered signal;
estimate a gradient based upon the computed error; and
update the FDE filter using the estimated gradient.

13. The system of claim 12, wherein the circuitry is configured to repeat the actions of claim 11 in a continuous loop so that the FDE filter is continuously updated and used to compensate for the interference as new signals are received.

14. The system of claim 12, further comprising circuitry configured to transform the signal from the time domain into the frequency domain prior to multiplying the signal by the FDE filter, and circuitry configured to transform the signal back to the time domain after multiplying the signal by the FDE filter.

15. The system of claim 14, further comprising circuitry configured to transform the error from the time domain into the frequency domain prior to estimating the gradient.

16. The system of claim 12, wherein the FDE filter is updated by adjusting the FDE filter weights according to
ΔW_{pq}(k)=μ∇_{pq}(k)
where ΔW_{pq}(k) is an adjustment of the weights of filter coefficients located at a pth row and a qth column of a filter matrix, μ denotes a step size of adjustment, and ∇_{pq}(k) is the gradient.

17. The system of claim 12, wherein the circuitry configured to compute the error comprises circuitry configured to compute the error using a constant modulus algorithm with which the intensity of the filtered signal is compared with the expected intensity.

18. The system of claim 12, wherein the circuitry configured to estimate a gradient comprises circuitry configured to estimate the gradient using the relation
∇_{pq}(k)=Eₚ(k)Y_{q}*(k)
where Eₚ(k) is the error from the pth mode channel in the frequency domain and Y_{q}(k) is the conjugated signal from the qth mode channel in the frequency domain.

19. The system of claim 12, further comprising circuitry configured to perform carrier recovery on the filtered signal to obtain a recovered signal and a laser phase noise associated with a laser that was used to transmit the received signal and wherein the circuitry is configured to calculate the error based also upon the laser phase noise.

20. The system of claim 12, further comprising circuitry configured to split the received signal into even and odd branches prior to multiplying the signal by an FDE filter, and wherein the circuitry configured to multiply the signal by an FDE filter comprises circuitry configured to multiply each branch by its own FDE filter.

21. The system of claim 12, wherein the circuitry configured to receive a signal comprises circuitry configured to receive multiple signals transmitted over multiple spatial modes of the optical fiber, and wherein the circuitry configured to multiply the signal by an FDE filter comprises circuitry configured to multiply each of the signals by the FDE filter.

22. The system of claim 12, further comprising circuitry configured to perform phase estimation on one mode channel and using estimated phase noise to perform carrier recovery for all mode channels when a single transmitter laser and a single local oscillator are used for all the mode channels.
